(19) United States
(12) Patent Application Publication
(10) Pub. No.: US 2020/0052281 A1
(43) Pub. Date: Feb. 13, 2020

(54) LOW-VOLTAGE LITHIUM-ION CELL AND THE MEHTOD THEREOF

(71) Applicant: Hanjun ZHANG, Newtown, CT (US)

(72) Inventor: Hanjun ZHANG, Newtown, CT (US)

(21) Appl. No.: 16/659,338

(22) Filed: Oct. 21, 2019

(30) Foreign Application Priority Data
Feb. 11, 2018 (CN) 201820251300.0

(51) Int. Cl. H01M 4/131; H01M 4/485; H01M 4/505; H01M 4/58; H01M 10/0525

(52) U.S. Cl. CPC H01M 4/131; H01M 4/485; H01M 4/366; H01M 4/5825; H01M 10/0525; H01M 4/505

(57) ABSTRACT

There is provided a lithium-ion battery and the method thereof. The lithium-ion battery includes a cathode, an electrolyte; and an anode arranged in sequence. The cathode is made of a material that comprises one selected from the group consisting of lithium iron phosphate, lithium cobalt oxide, lithium manganese oxide, lithium nickel cobalt manganese oxide, and lithium nickel cobalt aluminum oxide; and the anode is made of a material that comprises one selected from the group consisting of transition metal disulfides, metallic oxides, and carbon fluorides.

### CROSS-REFERENCE TO RELATED PATENT APPLICATION

This application claims priority to and the benefit of, Chinese Patent Application Serial No. 201820251300.0, filed Feb. 11, 2018. The entire disclosure of the above-identified application is incorporated herein by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference is individually incorporated by reference.

### TECHNICAL FIELD

The disclosure relates to the field of lithium battery technology, and more particularly relates to a low-voltage lithium-ion cell for household battery applications.

### BACKGROUND

With the increase and frequent usages of low and medium-end household appliances such as flashlights, radios, recorders, cameras, electronic clocks, remote controllers, Bluetooth mouse, toys, etc., the use of 1.5 V household batteries is becoming more and more popular.

The 1.5 V batteries are mainly primary batteries. For the primary batteries, the dominant batteries are carbon batteries (such as ordinary zinc-manganese batteries) and alkaline batteries (such as alkaline zinc-manganese batteries). Further, 1.5 V batteries can include lithium-iron disulfide batteries and rechargeable batteries (e.g. nickel-cadmium batteries and nickel-hydrogen batteries) with low market shares. At present, the annual market value of household battery industry in the world is more than ten billion of US dollars, and the batteries market is still growing. The use and disposal of these household batteries not only waste resources especially for primary batteries, but also bring potential threats to human health and the environment. For example, nickel cadmium batteries have been banned from producing and selling in more and more countries because of the toxicity of cadmium. Meanwhile, due to the limitations of materials resources, manufacturing technology and performance, the market size of the nickel hydrogen batteries was restricted and has been decreasing.

It is expected that the primary batteries should be replaced by rechargeable batteries in terms of both technological progress and environmental sustainability. Unfortunately, lithium-ion batteries at the forefront of technology and high-end status have always been outside the scope of the huge number of appliances using 1.5 V batteries mentioned above. Because the average output voltage of commercialized lithium-ion batteries is generally 3.2 V to 3.7 V, it is impossible for existing lithium-ion batteries to be directly used in the design of rated electricity according to the multiple level of 1.5 V.

At present, a kind of 1.5 V rechargeable lithium battery has appeared in the market, but this kind of lithium battery encapsulates ordinary lithium-ion battery and buck circuit into a battery shell of AA or AAA. Due to the extra use of buck circuit, this kind of battery is not only wasting resources and materials, but also greatly increases the cost. The 1.5 V rechargeable lithium battery mentioned above is not a desirable solution.

Although there is a trend that new, especially higher-end electrical appliances are designed directly for ordinary lithium-ion batteries in the circuit, there are still a wide variety and many middle and low-end household appliances whose rated voltage is designed according to a multiple of 1.5 V. In other words, for quite a long time, there is still a huge market demand for 1.5 V household batteries.

Lithium-ion batteries, which are in the forefront of technology and high-end status, are free from the application scope of many appliances using 1.5 V batteries, which is an urgent problem to be solved.

Therefore, our technical proposal is to start with lithium-ion batteries themselves, without adding any additional buck circuit, so that the discharge voltage of lithium-ion batteries can be in the appropriate range around 1.5 V. Lithium-ion batteries can replace the above-mentioned household batteries.

Therefore, a heretofore unaddressed need exists in the art to address the aforementioned deficiencies and inadequacies.

### SUMMARY

In view of the shortcomings of the existing technology and the actual requirements, the present disclosure provides a lithium-ion battery to replace the dry battery, such as 1.5 V dry battery, without any buck circuit in the lithium-ion battery itself.

To achieve this goal, the present disclosure provides the following technical solutions:

First, the disclosure provides a lithium-ion battery for replacing existing household batteries, and the lithium-ion battery includes a cathode, an electrolyte and an anode arranged in sequence, wherein the cathode material includes lithium iron phosphate, lithium cobalt oxide, lithium manganese oxide, lithium nickel cobalt manganese oxide, or lithium nickel cobalt aluminum oxide; the anode material includes transition metal disulfides, metallic oxides, or carbon fluorides.

In one embodiment, the metallic oxides include MnO₂, or TiO₂; the transition metal disulfides include TiS₂, MoS₂; and the carbon fluorides include graphite fluoride.

In one embodiment, the cathode material is lithium iron phosphate, and the anode material is TiS₂ or MoS₂; the cathode material is lithium cobalt oxide, and the anode material is TiS₂; the cathode material is lithium manganese oxide, and the anode material is TiS₂; the cathode material is lithium nickel cobalt manganese oxide, and the anode material is TiS₂; or the cathode material is lithium nickel cobalt aluminum oxide, and the anode material is TiS₂.

Alternatively, the disclosure provides a lithium-ion battery that includes a cathode, an electrolyte and an anode arranged in sequence, wherein the electrode potential of the anode material, the average delithiation voltage vs. lithium metal, is between 1.5 V and 3 V; and the electrode potential of the cathode material, the average lithiation voltage vs. lithium metal, is between 3 V and 4 V.

In one embodiment, the anode material is chosen from delithiated active materials, which can also be called as lithium-depleted active materials.

In one embodiment, the delithiated active materials include transition metal disulfides, metallic oxides, or carbon fluorides.

Alternatively, the disclosure provides a lithium-ion battery that includes a cathode, an electrolyte and an anode arranged in sequence, wherein the cathode material is chosen from lithiated active materials (also called lithium-rich active materials); the anode material is chosen from delithiated active materials; and the rated voltage of the battery is around 1.5 V.

In one embodiment, the lithiated active materials include lithium iron phosphate, lithium cobalt oxide, lithium manganese oxide, lithium nickel cobalt manganese oxide, or lithium nickel cobalt aluminum oxide.

Alternatively, the disclosure provides a method for manufacturing a lithium-ion battery, comprising the following steps:

S100: preparing the cathode paste of cathode material and the anode paste of anode material, wherein the electrode potential of the anode material is between 1.5 V and 3 V; and the electrode potential of the cathode material is between 3 V and 4 V;

S200: coating the cathode paste and anode paste on the first aluminum foil and the second aluminum foil, respectively, and then obtaining the cathode plate and anode plate after drying, rolling and cutting the plates;

S300: placing lithium battery separator between the cathode plate and anode plate, and then forming the battery according to the winding process; or after winding and punching, forming the battery according to the laminating process;

S400: placing the formed battery in a shell, then tab welding, vacuum drying and electrolyte injection, and then crimping or enveloping with plastic to obtain a battery finished product;

S500: performing one or more charge and discharge cycles on the battery finished product for the user to use.

Alternatively, the disclosure provides a method for manufacturing a lithium-ion battery, comprising the following steps:

S110: preparing the cathode paste of cathode material and the anode paste of anode material, wherein the cathode material is chosen from lithiated active materials; the anode material is chosen from delithiated active materials; and the rated voltage of the battery is around 1.5 V;

S210: coating the cathode paste and anode paste on the first aluminum foil and the second aluminum foil, respectively, and then obtaining the cathode plate and anode plate after drying, rolling and cutting the plates;

S310: placing lithium battery separator between the cathode plate and anode plate, and then forming the battery according to the winding process; or after winding and punching, forming the battery according to the laminating process;

S410: placing the formed battery in a shell, then tab welding, vacuum drying and electrolyte injection, and then crimping or enveloping with plastic to obtain a battery finished product;

S510: performing one or more charge and discharge cycles on the battery finished product for the user to use.

Alternatively, the disclosure provides a method for manufacturing a lithium-ion battery, comprising the following steps:

S120: preparing the cathode paste of cathode material and the anode paste of anode material, wherein the cathode material includes lithium iron phosphate, lithium cobalt oxide, lithium manganese oxide, lithium nickel cobalt manganese oxide, or lithium nickel cobalt aluminum oxide; the anode material includes transition metal disulfides, metallic oxides, or carbon fluorides;

S220: coating the cathode paste and anode paste on the first aluminum foil and the second aluminum foil, respectively, and then obtaining the cathode plate and anode plate after drying, rolling and cutting the plates;

S320: placing lithium battery separator between the cathode plate and anode plate, and then forming the battery according to the winding process; or after winding and punching, forming the battery according to the laminating process;

S420: placing the formed battery in a shell, then tab welding, vacuum drying and electrolyte injection, and then crimping or enveloping with plastic to obtain a battery finished product;

S520: performing one or more charge and discharge cycles on the battery finished product for the user to use.

On the one hand, unlike the 1.5 V lithium-ion battery in the prior art, the present disclosure can realize the original 1.5 V lithium-ion battery without a buck circuit. On the other hand, based on the cathode and anode materials disclosed, the present disclosure can utilize existing production lines to manufacture the original 1.5 V lithium-ion battery finished product.

### BRIEF DESCRIPTION OF THE DRAWINGS

The accompanying drawings illustrate one or more embodiments of the present disclosure and, together with the written description, serve to explain the principles of the disclosure. Wherever possible, the same reference numbers are used throughout the drawings to refer to the same or like elements of an embodiment.

FIG. 1 is a schematic diagram of the working principle of a lithium-ion battery.

FIG. 2 is a structure diagram of the lithium-ion battery.

FIG. 3 is a charge-discharge curve of the Li—TiS₂ half-cell in one embodiment at a rate of C/8, which means the battery is being charged or discharged under a defined current so that the battery would deliver its nominal rated capacity in 8 hours.

FIG. 4 is a charge-discharge curve at a rate of C/8 of the Li—MoS₂ half-cell lithium-ion battery in another embodiment.

FIG. 5 is a charge-discharge curve at a rate of C/8 of the lithium-ion battery in another embodiment.

FIG. 6 is a schematic diagram of charge-discharge cycle numbers.

FIG. 7 is a charge curve of the lithium-ion battery in another embodiment.

FIG. 8 is a charge-discharge curve at a rate of C/8 of the lithium-ion battery in another embodiment.

FIG. 9 is a flow chart of a method for manufacturing the lithium-ion battery in another embodiment.

### DETAILED DESCRIPTION

The present disclosure will now be described more fully hereinafter with reference to the accompanying drawings, in which exemplary embodiments of the present disclosure are shown. The present disclosure may, however, be embodied in many different forms and should not be construed as limited to the embodiments set forth herein. Rather, these embodiments are provided so that this disclosure is thorough and complete, and will fully convey the scope of the disclosure to those skilled in the art. Like reference numerals refer to like elements throughout.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It is appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the disclosure or of any exemplified term. Likewise, the disclosure is not limited to various embodiments given in this specification.

It is understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It is understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present disclosure.

It is understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It is also appreciated by those of skill in the art that references to a structure or feature that is disposed “adjacent” to another feature may have portions that overlap or underlie the adjacent feature.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It is further understood that the terms “comprises” and/or “comprising,” or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures It is understood that relative terms are intended to encompass different orientations of the device in addition to the orientation shown in the figures. For example, if the device in one of the figures is turned over, elements described as being on the “lower” side of other elements will then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements will then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present disclosure belongs. It is further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around,” “about,” “substantially” or “approximately” shall generally mean within 20 percent, preferably within 10 percent, and more preferably within 5 percent of a given value or range. Numerical quantities given herein are approximate, meaning that the terms “around,” “about,” “substantially” or “approximately” can be inferred if not expressly stated.

As used herein, the terms “comprise” or “comprising,” “include” or “including,” “carry” or “carrying,” “has/have” or “having,” “contain” or “containing,” “involve” or “involving” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the disclosure.

Embodiments of the disclosure are illustrated in detail hereinafter with reference to accompanying drawings. It should be understood that specific embodiments described herein are merely intended to explain the disclosure, but not intended to limit the disclosure.

In order to further elaborate the technical means adopted by the present disclosure and its effect, the technical scheme of the present disclosure is further illustrated in connection with the drawings and through specific mode of execution, but the present disclosure is not limited to the scope of the implementation examples.

The disclosure relates to the field of lithium battery technology, and more particularly to a low-voltage lithium-ion cell for household battery applications.

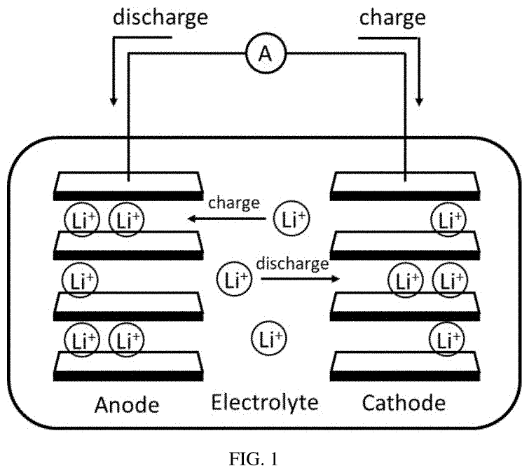

A lithium-ion cell or lithium-ion battery (LIB), as schematically illustrated in FIG. 1, is a type of rechargeable cell in which lithium ions move from the negative electrode, usually called as the anode, to the positive electrode, also called as the cathode, during discharge and back when charging.

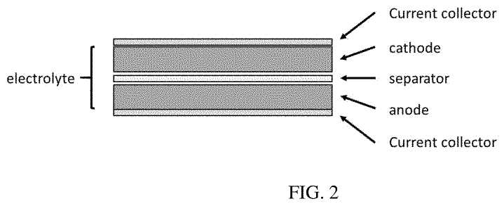

FIG. 2 is a structure diagram of the lithium-ion battery. Referring to FIG. 2, the LIB has three primary functional components. Specifically, the three primary functional components of a LIB are the cathode, anode and electrolyte. The separator is disposed between the cathode plate and anode plate. The electrolyte is typically a solution of one or more lithium salts in a mixture of two or more solvents. Lithium salts typically are lithium hexafluorophosphate (LiPF₆) lithium hexafluoroarsenate monohydrate (LiAsF₆), lithium perchlorate (LiClO₄), lithium tetrafluoroborate (LiBF₄), and lithium triflate (LiCF₃SO₃). Solvents are typically organic carbonates such as dimethyl carbonate, diethyl carbonate and ethylene carbonate. The role of the electrolyte is to serve as the medium for the transfer of charges, which are in the form of ions, between a pair of electrodes. the electrolyte should undergo no net chemical changes during the operation of the cell, and all Faradaic processes are expected to occur within the electrodes. Therefore, in an oversimplified expression, an electrolyte could be viewed as the inert component in the cell.

Conventionally, the active material for the negative electrode or the anode is graphite. The active material for the positive electrode or the cathode, is one of three materials: a layered oxide (such as lithium cobalt oxide), a spinel (such as lithium manganese oxide), and a polyanion (such as lithium iron phosphate).

A lithium-ion cell is an electrochemical cell having two half-cells. Each half-cell has an electrode, either the positive or the negative, and the electrolyte. In the LIB, the two half-cells share the same electrolyte. Each half-cell, namely, electrode, has a characteristic voltage, and the full-cell voltage can be obtained from the difference in voltage between electrodes.

Specifically, the average discharge voltages of popular commercial LIBs, which employ graphite as the negative electrode, range from 3.2 V to 3.7 V, depending upon the choices of the positive electrode. Currently there are no commercially available LIBs that deliver proper discharge voltage ranges so that these cells can replace existing household batteries. Indeed, there exist some so-called “1.5 V lithium-ion battery” products on market; however, these products are incorporated with electronic chips that transform the voltages of regular LIBs to 1.5 V. In other words, these products are integrated electronic devices, but they are not simply electrochemical cells or 1.5 V original lithium-ion batteries.

When the battery is charging up, the cathode gives up some of its lithium ions, which move through the electrolyte to the anode and remain there. The battery takes in and stores energy during this process. When the battery is discharging, the lithium ions move back across the electrolyte to the cathode, producing the energy. In both cases, electrons flow in the opposite direction to the ions around the outer circuit. Electrons do not flow through the electrolyte, which is effectively an insulating barrier.

The movements of ions (through the electrolyte) and electrons (around the external circuit, in the opposite direction) are interconnected processes, and if either stops, so does the other. If ions stop moving through the electrolyte because the battery completely discharges, electrons will not move through the outer circuit, either.

Intercalation/deintercalation reactions of Lithium ions (Lit), i.e. lithiation/delithiation, occurring alternately between the cathode and anode, as shown in FIG. 1. Specifically, during charging and discharging, driven by voltage difference, lithium ions move back and forth between the cathode and anode, and can be embedded or de-embedded in “holes” or “sandwiches” provided by electrode materials.

More specifically, during charging, the deintercalation reaction occurs at the cathode and the intercalation reaction occurs at the anode. The process is completely reversed during discharge, the intercalation reaction occurs at the cathode, and the deintercalation reaction occurs at the anode. Normally, the initial state of a lithium-ion battery is fully discharged.

The usual cathode material includes Lithium Iron Phosphate (LFP, LiFePO₄), Lithium Cobalt Oxide (LCO, LiCoO₂), Lithium Manganese Oxide (LMO, LiMn₂O₄), Lithium Nickel Cobalt Manganese Oxide (NCM, LiNiₓCo_{y}Mn_{z}O₂), or Lithium Nickel Cobalt Aluminum Oxide (NCA, LiNi_{0.8}Co_{0.15}Al_{0.05}O₂). As a successful commercialized material, the initial state of a usual cathode material is “lithium-rich”. The usual anode material includes graphite, Silicon/Carbon (Si/C), Hard Carbon, Tin (Sn), or Lithium Titanate (LTO, Li₄Ti₅O₁₂), and the initial state is “lithium-depleted”.

As shown in Tables 1 and 2, Table 1 presents the average discharge voltage of several common lithium-ion batteries based on different combinations of cathode and anode. Compared with Table 2, the average discharge voltage of lithium-ion batteries is still too high to directly replace household batteries even if LFP with relatively low voltage is used as the cathode material and LTO with relatively high voltage is used as the anode material. It is understood that, cathode potential (also called as cathode voltage) means the average voltage during lithiation vs. lithium metal, and anode potential (also called as anode voltage) means the average voltage during delithiation vs. lithium metal, wherein lithium metal means standard Li/Li⁺ electrode.

TABLE 1
Average discharge voltages of different types of LIBs that employ
variations of electrode pairs.

| | Cathode | | | | | | |
|---|---|---|---|---|---|---|---|
| | LCO | LMO | LFP | NCM | NCA | LCO | LFP |
| Cathode Voltage | 3.7 | 3.9 | 3.4 | 3.75 | 3.7 | 3.7 | 3.4 |
| (V) | | | | | | | |
| Anode | Graphite | | | | | LTO | |
| Anode Voltage (V) | 0.1 | | | | | 1.5 | |
| Full-cell Voltage | 3.6 | 3.8 | 3.3 | 3.65 | 3.6 | 2.2 | 1.9 |
| (V) | | | | | | | |

TABLE 2
Nominal discharge voltages of different types of household batteries.

| | Type | | | | |
|---|---|---|---|---|---|
| | Zinc-Carbon | Alkaline | Li—FeS₂ | NiCd | NiMH |
| Nominal Voltage | 1.5 | 1.5 | 1.5 | 1.2 | 1.2 |
| (V) | | | | | |

As shown in Table 1, the main point is that the voltage of lithium-ion battery using conventional cathode and anode materials is between 1.9 V and 3.8 V. Without the buck circuit, it is difficult to replace dry batteries with lithium-ion batteries. The above-mentioned problems are due to the potential difference between the cathode material and the anode material.

The present disclosure provides a lithium-ion battery of 1.5 V in general, and provides a method for manufacturing the lithium-ion battery with deliberately chosen electrodes so that these batteries discharge at proper voltage range and can replace the existing household batteries such as zinc-carbon, alkaline, lithium-iron disulfide, zinc-air, nickel-cadmium, nickel-metal hydride batteries, etc.

In one embodiment, a lithium-ion battery for replacing existing household batteries, includes a cathode, an electrolyte and an anode arranged in sequence, wherein the cathode material includes lithium iron phosphate, lithium cobalt oxide, lithium manganese oxide, lithium nickel cobalt manganese oxide, or lithium nickel cobalt aluminum oxide; the anode material includes transition metal disulfides, metallic oxides, or carbon fluorides.

In the present disclosure, the above-mentioned anode material in the embodiment is a lithium-depleted active material having a higher electrode potential than a conventional anode material. The anode material is matched with the cathode material in the embodiment, thereby eliminating the need for any additional buck circuit. The present embodiment can obtain a low-voltage lithium-ion battery with a discharge voltage about 1.5 V, so as to replace existing dry batteries.

In other words, in the present disclosure, the cathode material and the matched anode material are different from those of prior art. Specifically, the lithium-ion battery in the present embodiment can be the original lithium-ion battery without any additional buck circuit. According to the embodiment, the potential difference between the cathode material and the anode material can be about 1.5 V, and the lithium-ion battery can replace the existing household batteries such as zinc-carbon, alkaline, lithium-iron disulfide, zinc-air, nickel-cadmium, nickel-metal hydride batteries, etc.

In another embodiment, the metallic oxides include MnO₂, or TiO₂; the transition metal disulfides include TiS₂, MoS₂, or SnS₂, and the carbon fluorides include graphite fluoride.

In addition to the specific materials in the above-mentioned embodiments, the present disclosure can broadly select materials with potential between 1.5 V and 3 V as anode materials.

As shown in Table 3, in another embodiment, the present disclosure selects an around 2-2.2 V material as the anode material, for example, such as TiS₂ or MoS₂:

TABLE 3
Nominal discharge voltages of some instances of lithium-ion cells.

| Anode | TiS₂ | | | | | MoS₂ |
|---|---|---|---|---|---|---|
| Anode Voltage (V) | ~2.2 | | | | | ~2 |
| Cathode | LCO | LMO | NCM | NCA | LFP | |
| Cathode Voltage (V) | 3.7 | 3.9 | 3.75 | 3.7 | 3.4 | |
| Full-Cell Nominal Voltage | 1.5 | 1.5 | 1.5 | 1.5 | 1.2 | 1.4 |
| (V) | | | | | | |

In another embodiment, the cathode material is lithium iron phosphate, and the anode material is TiS₂ or MoS₂;

the cathode material is lithium cobalt oxide, and the anode material is TiS₂;

the cathode material is lithium manganese oxide, and the anode material is TiS₂, MnO₂ or graphite fluoride;

the cathode material is lithium nickel cobalt manganese oxide, and the anode material is TiS₂; or

the cathode material is lithium nickel cobalt aluminum oxide, and the anode material is TiS₂.

It is understood that, the above-mentioned embodiment provides some instances of cathode and anode material.

Alternatively, in another embodiment, the disclosure provides a lithium-ion battery, includes a cathode, an electrolyte and an anode arranged in sequence, wherein the electrode potential of the anode material is between 1.5 V and 3 V; and the electrode potential of the cathode material is between 3 and 4 V.

Preferably, the anode material is chosen from delithiated active materials (also called as lithium-depleted active materials).

Preferably, the delithiated active materials include transition metal disulfides, metallic oxides, or carbon fluorides.

Alternatively, in another embodiment, the disclosure provides a lithium-ion battery that includes a cathode, an electrolyte and an anode arranged in sequence, wherein the cathode material is chosen from lithiated active materials (also called lithium-rich active materials); the anode material is chosen from delithiated active materials; and the rated voltage of the battery is around 1.5 V.

In one embodiment, the lithiated active materials include lithium iron phosphate, lithium cobalt oxide, lithium manganese oxide, lithium nickel cobalt manganese oxide, or lithium nickel cobalt aluminum oxide.

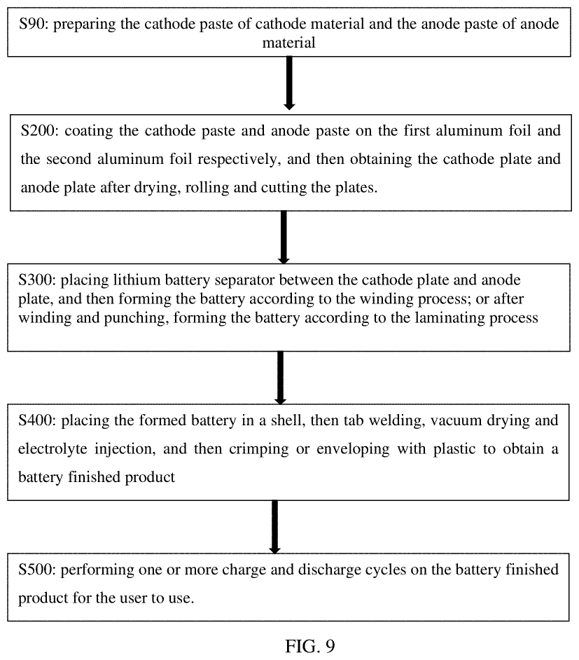

Alternatively, in another embodiment, the disclosure provides a method for manufacturing a lithium-ion battery, comprising the following steps, as shown in FIG. 9:

S100: preparing the cathode paste of cathode material and the anode paste of anode material, wherein the electrode potential of the anode material is between 1.5 V and 3 V; and the electrode potential of the cathode material is between 3 V and 4 V;

S200: coating the cathode paste and anode paste on the first aluminum foil and the second aluminum foil, respectively, and then obtaining the cathode plate and anode plate after drying, rolling and cutting the plates;

S300: placing lithium battery separator between the cathode plate and anode plate, and then forming the battery according to the winding process; or after winding and punching, forming the battery according to the laminating process;

S400: placing the formed battery in a shell, then tab welding, vacuum drying and electrolyte injection, and then crimping or enveloping with plastic to obtain a battery finished product;

S500: performing one or more charge and discharge cycles on the battery finished product for the user to use.

It is understood that, based on the cathode and anode materials disclosed, the present disclosure can utilize existing production lines to manufacture the original 1.5 V lithium-ion battery finished product without any additional buck circuit.

Specially, the above-mentioned embodiment utilizes two aluminum foils without any copper foil, which further reduces the cost. Since the potential of the anode material in the present disclosure is higher than that of the conventional anode material of a lithium-ion battery, aluminum foil can be used for both electrodes.

Preferably, preparing the cathode paste of cathode material and the anode paste of anode material comprising:

mixing the cathode and anode material with the conductive agent and the binder, and adding the solvent and then stirring into the cathode paste and anode paste, wherein the conductive agent includes acetylene black or carbon black or Super P, etc.; the binder includes polyvinylidene fluoride (PVdF) or carboxymethyl cellulose (CMC), etc.; and the solvent includes N-Methyl-2-Pyrrolidone (NMP) or water, etc.

In addition, it will be appreciated that lithium-ion cells of the present disclosure may comprise any source of TiS₂, MoS₂, electrolyte and cathode materials herein suitable for optimizing the performance of such lithium-ion cells. In the above-mentioned embodiments, TiS₂ and MoS₂ may be chemical reagents, cathode materials may be commercial products, and electrolyte may contain 1 mol/L LiFP₆ in EC/EMC/DMC (1:1:1 ratio, by volume).

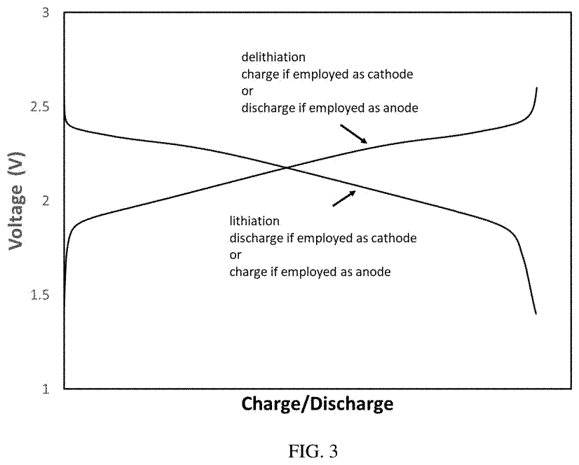

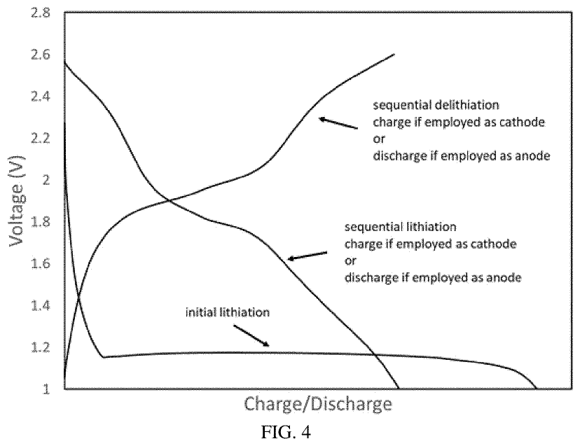

In one embodiment, the CR2032 type coin cell is utilized as the test vehicle, wherein the active material is TiS₂ (see FIG. 3) or MoS₂ (see FIG. 4), and the counter electrode is lithium metal.

FIG. 3 is a charge-discharge curve at a rate of C/8 of the Li—TiS₂ half-cell in the embodiment.

FIG. 4 is a charge-discharge curve at a rate of C/8 of the Li—MoS₂ half-cell in the embodiment.

When TiS₂ or MoS₂ is used as a negative electrode, the lithiation/delithiation experienced by TiS₂ or MoS₂ during whole-cell (also called as full-cell) charging and discharging is the opposite to the situations when TiS₂ or MoS₂ is used as positive electrodes, i.e. Exxon and Moli Energy rechargeable lithium batteries. In a full-cell, the average discharge voltage of TiS₂ anode is around 2.2V, and that of MoS₂ anode is around 2 V.

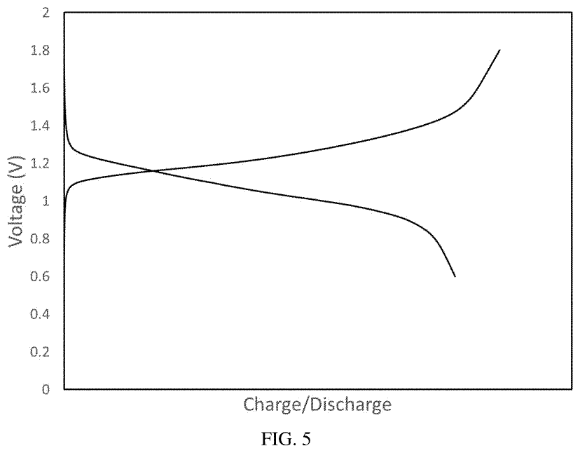

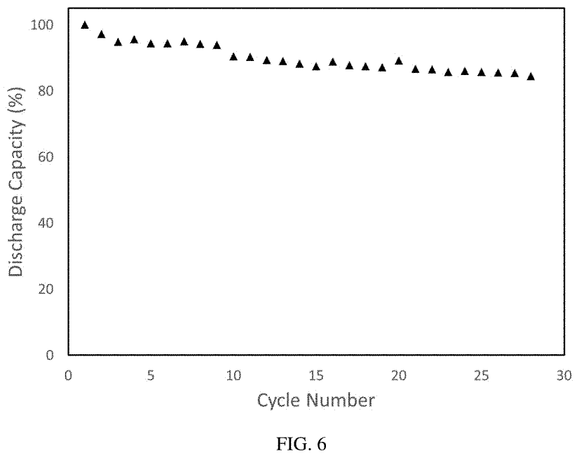

In one embodiment, the positive electrode includes about 93 weight % (hereinafter “wt %”) lithium iron phosphate, 3 wt % super P as conducting agent, and 4 wt % polyvinylidene fluoride as binder coated onto an aluminum foil. The negative electrode includes about 91 wt % titanium disulfide, 5 wt % super P, and 4 wt % polyvinylidene fluoride coated onto an aluminum foil. The electrolyte is 1 mol/L LiFP₆ in EC/EMC/DMC (1:1:1 ratio, by volume). Both electrodes are dried at 80° C. under vacuum for 24 hours and a lithium-ion cell as the CR2032 type coin cell is assembled in an argon filled glove box. The coin cell is charged-discharged at a C/8 rate within a range of 0.6-1.9 V at room temperature. The results are shown in FIGS. 5 and 6.

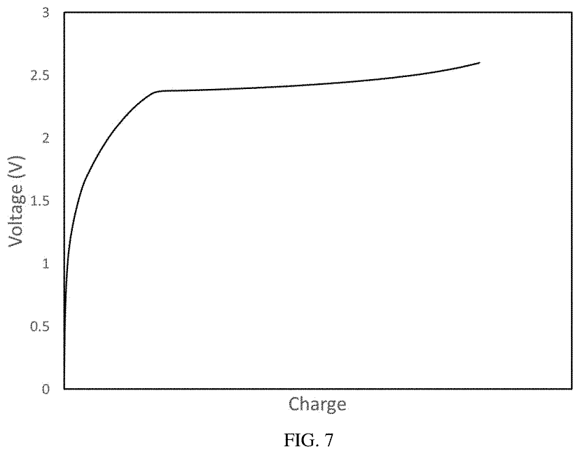

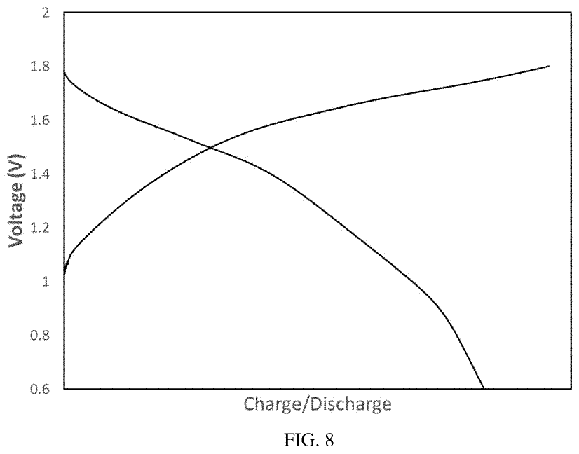

In one embodiment, the positive electrode includes about 93 wt % lithium iron phosphate, 3 wt % super P as conducting agent, and 4 wt % polyvinylidene fluoride as binder coated onto an aluminum foil. The negative electrode includes about 91 wt % molybdenum disulfide, 5 wt % super P, and 4 wt % polyvinylidene fluoride coated onto an aluminum foil. The electrolyte is 1 mol/L LiFP₆ in EC/EMC/DMC (1:1:1 ratio, by volume). Both electrodes are dried at 80° C. under vacuum for 24 hours and a lithium-ion cell as the CR2032 type coin cell is assembled in an argon filled glove box. As shown in FIG. 7, the coin cell might need to be charged at a C/8 rate to 2.6 V for the first step in order to transform H type molybdenum disulfide to T type lithiated molybdenum disulfide as a phase transition, and then the cell is charged-discharged at the same rate within a range of 0.6-1.8V at room temperature, as shown in FIG. 8.

Alternatively, in another embodiment, the disclosure provides a method for manufacturing a lithium-ion battery, comprising the following steps:

S110, preparing the cathode paste of cathode material and the anode paste of anode material, wherein the cathode material is chosen from lithiated active materials; the anode material is chosen from delithiated active materials; and the rated voltage of the battery is around 1.5 V;

S210: coating the cathode paste and anode paste on the first aluminum foil and the second aluminum foil, respectively, and then obtaining the cathode plate and anode plate after drying, rolling and cutting the plates;

S310: placing lithium battery separator between the cathode plate and anode plate, and then forming the battery according to the winding process; or after winding and punching, forming the battery according to the laminating process;

S410: placing the formed battery in a shell, then tab welding, vacuum drying and electrolyte injection, and then crimping or enveloping with plastic to obtain a battery finished product;

S510: performing one or more charge and discharge cycles on the battery finished product for the user to use.

It can be understood that for the skilled in the art, without a buck circuit, the present disclosure can realize the original 1.5 V lithium-ion battery.

Alternatively, in another embodiment, the disclosure provides a method for manufacturing a lithium-ion battery said above, comprising the following steps:

S120: preparing the cathode paste of cathode material and the anode paste of anode material, wherein the cathode material includes lithium iron phosphate, lithium cobalt oxide, lithium manganese oxide, lithium nickel cobalt manganese oxide, or lithium nickel cobalt aluminum oxide; the anode material includes transition metal disulfides, metallic oxides, or carbon fluorides;

S220: coating the cathode paste and anode paste on the first aluminum foil and the second aluminum foil, respectively, and then obtaining the cathode plate and anode plate after drying, rolling and cutting the plates;

S320: placing lithium battery separator between the cathode plate and anode plate, and then forming the battery according to the winding process; or

after winding and punching, forming the battery according to the laminating process;

S420: placing the formed battery in a shell, then tab welding, vacuum drying and electrolyte injection, and then crimping or enveloping with plastic to obtain a battery finished product;

S520: performing one or more charge and discharge cycles on the battery finished product for the user to use.

The foregoing description of the present disclosure, along with its associated embodiments, has been presented for purposes of illustration only. It is not exhaustive and does not limit the present disclosure to the precise form disclosed. Those skilled in the art will appreciate from the foregoing description that modifications and variations are possible considering the above teachings or may be acquired from practicing the disclosed embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims considering their full scope of equivalents.

What is claimed is:

1. A lithium-ion battery, comprising:
a cathode;
an electrolyte; and
an anode arranged in sequence, wherein
the cathode is made of a material that comprises one selected from the group consisting of lithium iron phosphate, lithium cobalt oxide, lithium manganese oxide, lithium nickel cobalt manganese oxide, and lithium nickel cobalt aluminum oxide; and
the anode is made of a material that comprises one selected from the group consisting of transition metal disulfides, metallic oxides, and carbon fluorides.

2. The lithium-ion battery of claim 1, wherein
the metallic oxides comprise MnO₂, or TiO₂;
the transition metal disulfides comprise TiS₂, MoS₂; and
the carbon fluorides comprise graphite fluoride.

3. The lithium-ion battery of claim 1, wherein
the material of the cathode is lithium iron phosphate, and the material of the anode is TiS₂ or MoS₂;
the material of the cathode is lithium cobalt oxide, and the material of the anode is TiS₂;
the material of the cathode is lithium nickel cobalt manganese oxide, and the material of the anode is TiS₂; or
the material of the cathode is lithium nickel cobalt aluminum oxide, and the material of the anode is TiS₂.

4. The lithium-ion battery of claim 1, wherein
the material of the anode has an electrode potential and the electrode potential, the average delithiation voltage vs. lithium metal, is between 1.5 V and 3 V; and
the material of the cathode has an electrode potential and the electrode potential of the cathode material, the average lithiation voltage vs. lithium metal, is between 3 V and 4 V correspondingly.

5. The lithium-ion battery of claim 4, wherein the material of the anode is chosen from delithiated active materials.

6. The lithium-ion battery of claim 5, wherein the delithiated active materials comprise transition metal disulfides, metallic oxides, or carbon fluorides.

7. The lithium-ion battery of claim 6, wherein
the transition metal disulfides comprise TiS₂, MoS₂;
the metallic oxides comprise MnO₂, or TiO₂; and
the carbon fluorides comprise graphite fluoride.

8. The lithium-ion battery of claim 4, wherein
the material of the cathode comprises lithium iron phosphate, lithium cobalt oxide, lithium manganese oxide, lithium nickel cobalt manganese oxide, or lithium nickel cobalt aluminum oxide.

9. The lithium-ion battery of claim 4, wherein
the material of the cathode is lithium iron phosphate, and the anode material is TiS₂ or MoS₂;
the material of the cathode is lithium cobalt oxide, and the material of the anode is TiS₂;
the material of the cathode is lithium nickel cobalt manganese oxide, and the material of the anode is TiS₂; or
the material of the cathode is lithium nickel cobalt aluminum oxide, and the material of the anode is TiS₂.

10. A lithium-ion battery, includes a cathode, an electrolyte and an anode arranged in sequence, wherein
the cathode material is chosen from lithiated active materials;
the anode material is chosen from delithiated active materials; and
the rated voltage of the battery is around 1.5 V.

11. The lithium-ion battery of claim 10, wherein the lithiated active materials comprises lithium iron phosphate, lithium cobalt oxide, lithium manganese oxide, lithium nickel cobalt manganese oxide, or lithium nickel cobalt aluminum oxide.

12. The lithium-ion battery of claim 10, wherein the delithiated active materials include transition metal disulfides, metallic oxides, or carbon fluorides.

13. The lithium-ion battery of claim 12, wherein
the transition metal disulfides comprise TiS₂, MoS₂;
the metallic oxides comprise MnO₂, or TiO₂; and
the carbon fluorides comprise graphite fluoride.

14. The lithium-ion battery of claim 10, wherein
the cathode material is lithium iron phosphate, and the anode material is TiS₂ or MoS₂;
the cathode material is lithium cobalt oxide, and the anode material is TiS₂;
the cathode material is lithium manganese oxide, and the anode material is TiS₂;
the cathode material is lithium nickel cobalt manganese oxide, and the anode material is TiS₂; or
the cathode material is lithium nickel cobalt aluminum oxide, and the anode material is TiS₂.

15. A method for manufacturing a lithium-ion battery of claim 1, comprising the following steps:
S100: preparing cathode paste of a cathode material and anode paste of an anode material;
S200: coating the cathode paste and the anode paste on a first aluminum foil and a second aluminum foil, respectively, and then obtaining a cathode plate and an anode plate after the cathode plate and the anode plate are dried, rolled and cut;
S300: placing lithium battery separator between the cathode plate and anode plate, and then forming the lithium-ion battery according to a winding process, or after the winding processing and a punching process, forming the lithium-ion battery according to a laminating process;
S400: placing the lithium-ion battery in a shell, then performing tab welding, vacuum drying and electrolyte injection, and then crimping or enveloping with plastic to obtain the lithium-ion battery; and
S500: performing one or more charge cycle and one or more discharge cycle on the lithium-ion battery.

16. The method of claim 15, wherein the cathode material is chosen from lithiated active materials; and the anode material is chosen from delithiated active materials; and the rated voltage of the battery is around 1.5 V.

17. The method of claim 15 wherein the anode material has an electrode potential and the electrode potential of the anode material is between 1.5 V and 3 V; and the cathode material has an electrode potential and the electrode potential of the cathode material is between 3 V and 4 V.

18. The method of claim 16, wherein the cathode material includes lithium iron phosphate, lithium cobalt oxide, lithium manganese oxide, lithium nickel cobalt manganese oxide, or lithium nickel cobalt aluminum oxide; and the anode material includes transition metal disulfides, metallic oxides, or carbon fluorides.

19. The method of claim 16, wherein the delithiated active materials include transition metal disulfides, metallic oxides, or carbon fluorides.
